(19) United States
(12) Patent Application Publication
(10) Pub. No.: US 2020/0139991 A1
(43) Pub. Date: May 7, 2020

(54) ELECTRONIC DEVICE FOR VEHICLE AND OPERATING METHOD OF ELECTRONIC DEVICE FOR VEHICLE

(71) Applicant: LG ELECTRONICS INC., Seoul (KR)

(72) Inventors: Soryoung KIM, Seoul (KR); Chiwon SONG, Seoul (KR)

(73) Assignee: LG ELECTRONICS INC., Seoul (KR)

(21) Appl. No.: 16/500,746

(22) PCT Filed: Aug. 23, 2019
(86) PCT No.: PCT/KR2019/010732

§ 371 Date: Oct. 3, 2019

(51) Int. Cl. B60W 60/00; G05D 1/00

(52) U.S. Cl. CPC B60W 60/0051; B62D 1/183; B60W 60/0053; G05D 1/0061

(57) ABSTRACT

The present disclosure relates to an electronic device for a vehicle including: at least one interface unit; and at least one processor for receiving, through the interface unit, a sensing signal generated by force applied to a steering wheel in a direction different from a rotation direction of the steering wheel, and providing a control signal to switch a travel mode between a manual mode and an autonomous mode based on the sensing signal. At least one of an autonomous vehicle, a user terminal or a server of the present disclosure may be linked to an artificial intelligence module, a drone (unmanned aerial vehicle (UAV), a robot, an augmented reality (AR) device, a virtual reality (VR) device, and devices associated with 5G services, etc.

### TECHNICAL FIELD

The present disclosure relates to an electronic device for vehicles and an operating method of the electronic device for vehicles.

### BACKGROUND ART

A vehicle is an apparatus movable in a desired direction by a user seated therein. A representative example of such a vehicle is an automobile. An autonomous vehicle means a vehicle which can automatically travel without manipulation of a person.

An autonomous vehicle may switch a travel mode between a manual mode and an autonomous mode. Mode switching may be achieved in accordance with an intention of the user. However, when an intention of the user is incorrectly reflected upon switching of the travel mode between the manual mode and the autonomous mode, there may be a possibility of malfunction, or there may be a problem associated with safety during travel.

### DISCLOSURE

### Technical Problem

Therefore, the present disclosure has been made in view of the above problems, and it is an object of the present disclosure to provide an electronic device for a vehicle capable of precisely reflecting an intention of the user upon switching of a travel mode between an autonomous mode and a manual mode.

It is another object of the present disclosure to provide an operating method of an electronic device for a vehicle capable of precisely reflecting an intention of the user upon switching of a travel mode between an autonomous mode and a manual mode.

Objects of the present disclosure are not limited to the above-described objects, and other objects of the present disclosure not yet described will be more clearly understood by those skilled in the art from the following detailed description.

### Technical Solution

In accordance with an aspect of the present disclosure, the above objects can be accomplished by the provision of an electronic device for a vehicle including a processor for providing a control signal to switch a travel mode between a manual mode and an autonomous mode based on data sensed by force applied to a steering wheel.

In accordance with an embodiment of the present disclosure, the processor provides a first control signal to switch the travel mode from the manual mode to the autonomous mode upon receiving a first sensing signal generated by force applied in a first direction.

In accordance with an embodiment of the present disclosure, the processor provides a control signal to position the steering wheel at a normal position where there is no rotation of the steering wheel while cutting off operative connection of the steering wheel to steered wheels, upon receiving the first sensing signal.

In accordance with an embodiment of the present disclosure, the processor provides a control signal to hide at least a portion of the steering wheel into a cockpit module, upon receiving the first sensing signal.

In accordance with an embodiment of the present disclosure, the processor provides a second sensing signal to switch the travel mode from the autonomous mode to the manual mode, upon receiving a second sensing signal generated by force applied in a second direction different from the first direction.

In accordance with an embodiment of the present disclosure, the processor provides a control signal to expose at least a portion of the steering wheel in a hidden state, upon receiving the second sensing signal generated by the force applied in the second direction different from the first direction.

In accordance with an embodiment of the present disclosure, the processor provides a control signal to operatively connect the steering wheel and the steered wheels, upon receiving the second sensing signal.

In accordance with an embodiment of the present disclosure, the processor receives information as to a travel section through the interface unit, and provides a second control signal to switch the travel mode from the autonomous mode to the manual mode, upon determining that a residual section for autonomous travel is not greater than a reference distance.

In accordance with an embodiment of the present disclosure, the processor provides a control signal to output an interface providing information as to a time when the travel mode is switched from the autonomous mode to the manual mode.

In accordance with an embodiment of the present disclosure, the processor receives information as to a state of a user through the interface unit, and provides a control signal to park the vehicle in a safe area, upon determining the state of the user to be a manual travel impossible state.

In accordance with an embodiment of the present disclosure, the processor receives an electrical signal generated from a user input device through the interface unit, and provides the control signal upon receiving the sensing signal in a state of receiving the electrical signal.

In accordance with an embodiment of the present disclosure, the processor provides a control signal to output a user intention identification interface, upon receiving the sensing signal.

In accordance with an embodiment of the present disclosure, the processor provides the control signal, upon determining that a sensing value based on the sensing signal is not lower than a reference value.

In accordance with an embodiment of the present disclosure, the processor provides the control signal, upon continuously receiving the sensing signal for a predetermined time or more.

In accordance with an embodiment of the present disclosure, the processor provides a first control signal to switch the travel mode to a fully autonomous mode, upon receiving a first sensing signal generated by force applied to the steering wheel in a first state, and provides a second control signal to switch the travel mode to a semi-autonomous mode, upon receiving a second sensing signal generated by force applied to the steering wheel in a second state. The first state is a state in which the steering wheel is closer to a cockpit module than in the second state.

In accordance with an embodiment of the present disclosure, the processor receives information as to a travel section through the interface unit, and provides a control signal to output an interface rejecting an autonomous mode switching, upon determining that a residual section for autonomous travel is not greater than a reference distance at a time when the sensing signal is received by the processor.

In accordance with an embodiment of the present disclosure, the processor determines whether or not the residual section for autonomous travel is not greater than the reference distance when the steering wheel is in a first state. The first state is a state in which the steering wheel is closer to a cockpit module than in a steering wheel state in the manual mode.

In accordance with an embodiment of the present disclosure, the processor provides a control signal to output an interface providing information as to a time when the travel mode is switched from the manual mode to the autonomous mode.

In accordance with another aspect of the present disclosure, the above objects can be accomplished by the provision of an electronic device for a vehicle including a processor for switching a travel mode from a manual mode to an autonomous mode, upon sensing force pushing a steering wheel in a forward direction of the vehicle through a sensor, and switching the travel mode from the autonomous mode to the manual mode, upon sensing force pulling the steering wheel in a rearward direction of the vehicle through the sensor.

In accordance with another aspect of the present disclosure, the above objects can be accomplished by the provision of an operating method of an electronic device for a vehicle including the steps of: receiving, by at least one processor, a sensing signal generated by force applied to a steering wheel in a direction different from a rotation direction of the steering wheel; and providing, by at least one processor, a control signal to switch a travel mode between a manual mode and an autonomous mode based on the sensing signal.

Concrete matters of other embodiments will be apparent from the detailed description and the drawings.

### Advantageous Effects

In accordance with the present disclosure, one or more effects are provided as follows.

First, the user applies force to the steering wheel in a direction different from a rotation direction of the steering wheel and, as such, there is an effect of surely transmitting an intention of mode switching to the vehicle.

Second, mode switching is carried out when applied force is not lower than a critical value or force is applied for a predetermined time or more and, as such, there is an effect of preventing malfunction of mode switching.

Third, the steering wheel is hidden when the travel mode is switched to the autonomous mode and, as such, there is an effect of enhancing user convenience in accordance with an enhancement in space utility of the cabin.

The effects of the present disclosure are not limited to the above-described effects and other effects which are not described herein may be derived by those skilled in the art from the description of the claims.

### DESCRIPTION OF DRAWINGS

FIG. 1 is a view illustrating an appearance of a vehicle according to an embodiment of the present disclosure.

FIG. 2 is a control block diagram of the vehicle according to an embodiment of the present disclosure.

FIG. 3 is a control block diagram of a configuration of a portion of the vehicle according to an embodiment of the present disclosure.

FIG. 4 is a control block diagram of an electronic device according to an embodiment of the present disclosure.

FIG. 5 is a flowchart of the electronic device according to an embodiment of the present disclosure.

FIGS. 6 and 7 are views schematically illustrating the electronic device and a steering wheel according to an embodiment of the present disclosure.

FIG. 8 is a view schematically illustrating the vehicle, which currently travels, in accordance with an embodiment of the present disclosure.

FIG. 9 is a view schematically illustrating a portion of the vehicle according to an embodiment of the present disclosure.

FIGS. 10 and 11 are views referred to for explanation of operative connection between the steering wheel and steered wheels and cut-off of the operative connection.

FIGS. 12 and 13 are views referred to for explanation of travel mode switching according to an embodiment of the present disclosure.

FIG. 14 illustrates an example of basic operations of an autonomous vehicle and a 5G network in a 5G communication system.

FIG. 15 illustrates an example of application operations of the autonomous vehicle and the 5G network in the 5G communication system.

FIGS. 16 to 19 illustrate an example of operation of the autonomous vehicle using 5G communication.

### BEST MODE

Reference will now be made in detail to the exemplary embodiments of the present disclosure, examples of which are illustrated in the accompanying drawings. Identical or similar constituent elements will be designated by the same reference numeral even though they are depicted in different drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another element.

It will be understood that, when an element is referred to as being “connected to” or “coupled to” another element, it may be directly connected or coupled to the other element, or intervening elements may be present. In contrast, when an element is referred to as being “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or combinations thereof.

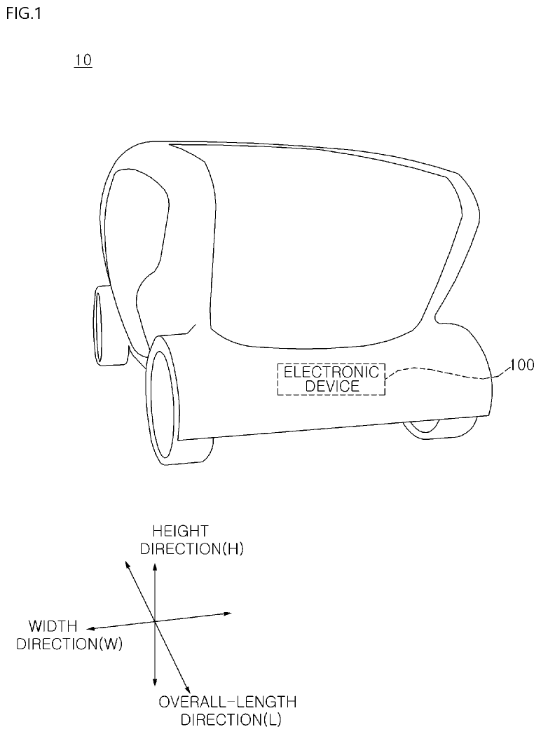

FIG. 1 is a view illustrating a vehicle according to an embodiment of the present disclosure.

Referring to FIG. 1, the vehicle 10 according to the embodiment of the present disclosure is defined as a transportation means to travel on a road or a railway line. The vehicle 10 is a concept including an automobile, a train, and a motorcycle. The vehicle 10 may be a concept including all of an internal combustion engine vehicle including an engine as a power source, a hybrid vehicle including an engine and an electric motor as a power source, an electric vehicle including an electric motor as a power source, etc. The vehicle 10 may be a shared vehicle. The vehicle 10 may be an autonomous vehicle.

An electronic device 100 of a vehicle (hereinafter referred to as an “electronic device”) may be included in the vehicle 10. The electronic device 100 may be a device for controlling switching of a travel mode between an autonomous mode and a manual mode.

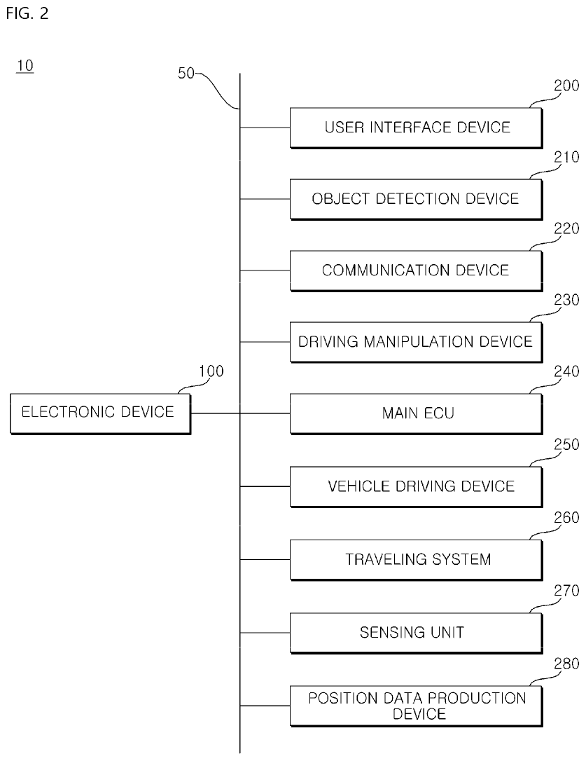

FIG. 2 is a control block diagram of the vehicle according to an embodiment of the present disclosure.

Referring to FIG. 2, the vehicle 10 may include the electronic device 100, a user interface device 200, an object detection device 210, a communication device 220, a driving manipulation device 230, a main electronic control unit (ECU) 240, a vehicle driving device 250, a traveling system 260, a sensing unit 270, and a position data production device 280.

The electronic device 100 may control a travel mode between an autonomous mode and a manual mode. The electronic device 100 may provide a control signal to switch the travel mode from the autonomous mode to the manual mode. The electronic device 100 may automatically switch the travel mode from the autonomous mode to the manual mode based on an acquired signal, acquired information or acquired data. The electronic device 100 may manually switch the travel mode from the autonomous mode to the manual mode based on user input. The electronic device 100 may provide a control signal to switch the travel mode from the manual mode to the autonomous mode. The electronic device 100 may provide a control signal to automatically switch the travel mode from the manual mode to the autonomous mode based on an acquired signal, acquired information or acquired data. The electronic device 100 may provide a control signal to manually switch the travel mode from the manual mode to the autonomous mode based on user input.

The user interface device 200 is a device for enabling communication between the vehicle 10 and the user. The user interface device 200 may receive user input, and may provide information produced in the vehicle 10 to the user. The vehicle 10 may realize user interface (UI) or user experience (UX) through the user interface device 200. The user interface device 200 may include an input unit, an output unit, and a user monitoring device. The user interface device 200 may include an input device such as a touch input device, a mechanical input device, a voice input device, or a gesture input device. The user interface device 200 may include an output device such as a speaker, a display, or a haptic module. The user interface device 200 may include a user monitoring device such as a driver monitoring system (DMS) or an internal monitoring system (IMS).

The object detection device 210 may produce information as to an object outside the vehicle 10. Information as to an object may include at least one of information as to whether or not there is an object, position information as to an object, information as to a distance between the vehicle 10 and an object, or information as to a relative speed of the vehicle 10 with respect to an object. The object detection device 210 may detect an object outside the vehicle 10. The object detection device 210 may include at least one sensor capable of detecting an object outside the vehicle 10. The object detection device 210 may include at least one of a camera, a radar, a lidar, an ultrasound sensor or an infrared sensor. The object detection device 210 may provide data as to an object produced based on a sensing signal generated in the sensor to at least one electronic device included in the vehicle.

The camera may produce information as to an object outside the vehicle 10, using an image. The camera may include at least one lens, at least one image sensor, and at least one processor electrically connected to the image sensor, to process a signal received from the image sensor and to produce data as to an object based on the processed signal.

The camera may be at least one of a mono camera, a stereo camera, or an around view monitoring (AVM) camera. Using various image processing algorithms, the camera may acquire position information of an object, information as to a distance from the object or information as to a relative speed with respect to the object. For example, the camera may acquire information as to a distance from an object and information as to a relative speed with respect to the object from an acquired image, based on a variation in the size of the object according to time. For example, the camera may acquire distance information and relative speed information associated with an object through a pin hole model, road surface profiling, etc. For example, the camera may acquire distance information and relative speed information associated with an object from a stereo image acquired by a stereo camera, based on disparity information.

In order to photograph an outside of the vehicle, the camera may be mounted at a position in the vehicle where the camera can secure a field of view (FOV). In order to acquire an image in front of the vehicle, the camera may be disposed in an inner compartment of the vehicle in the vicinity of a front windshield. The camera may be disposed around a front bumper or a radiator grill. In order to acquire an image in rear of the vehicle, the camera may be disposed in the inner compartment of the vehicle in the vicinity of a back glass. The camera may be disposed around a rear bumper, a trunk or a tail gate. In order to acquire an image at a lateral side of the vehicle, the camera may be disposed in the inner compartment of the vehicle in the vicinity of at least one of side windows. Alternatively, the camera may be disposed around a side mirror, a fender, or a door.

The radar may produce information as to an object outside the vehicle 10 using a radio wave. The radar may include an electromagnetic wave transmitter, an electromagnetic wave receiver, and at least one processor electrically connected to the electromagnetic wave transmitter and the electromagnetic wave receiver, to process a received signal and to produce data as to an object based on the processed signal. The radar may be embodied through a pulse radar system or a continuous wave radar system based on a radio wave emission principle. The radar may be embodied through a frequency modulated continuous wave (FMCW) system or a frequency shift keyong (FSK) system selected from continuous wave radar systems in accordance with a signal waveform. The radar may detect an object, a position of the detected object, and a distance and a relative speed with respect to the detected object by means of an electromagnetic wave on the basis of time of flight (TOF) or phase shift. The radar may be disposed at an appropriate position outside the vehicle in order to sense an object disposed at a front, rear or lateral side of the vehicle.

The lidar may produce information as to an object outside the vehicle 10, using laser light. The lidar may include an optical transmitter, an optical receiver, and at least one processor electrically connected to the optical transmitter and the optical receiver, to process a received signal and to produce data as to an object based on the processed signal. The lidar may be embodied through a time-of-flight (TOF) system and a phase shift system. The lidar may be implemented in a driven manner or a non-driven manner. When the lidar is implemented in a driven manner, the lidar may detect an object around the vehicle 10 while being rotated by a motor. When the lidar is implemented in a non-driven manner, the lidar may detect an object disposed within a predetermined range with reference to the vehicle by optical steering. The vehicle 10 may include a plurality of non-driven lidars. The lidar may detect an object, a position of the detected object, and a distance and a relative speed with respect to the detected object by means of laser light on the basis of time of flight (TOF) or phase shift. The lidar may be disposed at an appropriate position outside the vehicle in order to sense an object disposed at a front, rear or lateral side of the vehicle.

The communication device 220 may exchange a signal with a device disposed outside the vehicle 10. The communication device 220 may exchange a signal with at least one of infrastructure (for example, a server or a broadcasting station) or another vehicle. The communication device 220 may include at least one of a transmission antenna, a reception antenna, a radio frequency (RF) circuit or an RF element capable of implementing various communication protocols in order to execute communication.

The communication device 220 may communicate with a device disposed outside the vehicle 10, using a 5G (for example, new radio (NR)) system. The communication device 220 may implement V2X (V2V, V2D, V2P or V2N) communication using the 5G system.

The driving manipulation device 230 is a device for receiving user input for driving. In a manual mode, the vehicle 10 may be driven based on a signal provided by the driving manipulation device 230. The driving manipulation device 230 may include a steering input device (for example, a steering wheel), an acceleration input device (for example, an accelerator pedal), and a brake input device (for example, a brake pedal).

The main ECU 240 may control overall operation of at least one electronic device included in the vehicle 10.

The driving control device 250 is a device for electrically controlling various vehicle driving devices in the vehicle 10. The driving control device 250 may include a powertrain driving control device, a chassis driving control device, a door/window driving control device, a safety device driving control device, a lamp driving control device, and an air conditioner driving control device. The powertrain driving control device may include a power source driving control device and a transmission driving control device. The chassis driving control device may include a steering driving control device, a brake driving control device, and a suspension driving control device. Meanwhile, the safety device driving control device may include a safety belt driving control device for safety belt control.

The driving control device 250 may include at least one electronic control device (for example, a control electronic control unit (ECU)). The driving control device 250 may control a vehicle driving device based on a signal received from the traveling system 260.

The traveling system 260 may control motion of the vehicle 10 or may generate a signal for outputting information to the user, based on data as to an object received from the object detection device 210. The traveling system 260 may provide the generated signal to at least one of the user interface device 200, the main ECU 240 or the vehicle driving device 250.

The traveling system 260 may be a concept including an advanced driver-assistance system (ADAS). The ADAS 260 may embody an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, an adaptive high beam assist (HBA) system, an auto-parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous travel path based on data received from at least one of other electronic devices in the vehicle 10. The autonomous ECU may set an autonomous travel path based on data received from at least one of the user interface device 200, the object detection device 210, the communication device 220, the sensing unit 270, or the position data production device 280. The autonomous traveling ECU may generate a control signal to enable the vehicle 10 to travel along the autonomous travel path. The control signal generated from the autonomous traveling ECU may be provided to at least one of the main ECU 240 or the vehicle driving device 250.

The sensing unit 270 may sense a state of the vehicle. The sensing unit 270 may include at least one of an inertial measurement unit (IMU) sensor, a collision sensor, a wheel sensor, a speed sensor, a slope sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an ambient light sensor, or a pedal position sensor. Meanwhile, the inertial measurement unit (IMU) sensor may include at least one of an acceleration sensor, a gyro sensor, or a magnetic sensor.

The sensing unit 270 may produce vehicle state data based on a signal generated from at least one sensor. The vehicle state data may be information produced based on data sensed in various sensors included within the vehicle. The sensing unit 270 may produce vehicle posture data, vehicle motion data, vehicle yaw data, vehicle roll data, vehicle pitch data, vehicle collision data, vehicle direction data, vehicle angle data, vehicle speed data, vehicle acceleration data, vehicle inclination data, vehicle forward/backward movement data, vehicle weight data, battery data, fuel data, tire air pressure data, internal vehicle temperature data, internal vehicle humidity data, a steering wheel rotation angle, ambient illumination outside the vehicle, data as to a pressure applied to the accelerator pedal, data as to a pressure applied to the brake pedal, etc.

The position data production device 280 may produce position data of the vehicle 10. The position data production device 280 may include at least one of a global positioning system (GPS) or a differential global positioning system (DGPS). The position data production device 280 may produce position data of the vehicle 10 based on a signal generated from at least one of the GPS or the DGPS. In accordance with an embodiment, the position data production device 280 may correct position data based on at least one of an inertial measurement unit (IMU) of the sensing unit 270 or a camera of the object detection device 210. The position data production device 280 may be referred to as a “global navigation satellite system (GNSS)”.

The vehicle 10 may include an inner communication system 50. Plural electronic devices included in the vehicle 10 may exchange a signal via the inner communication system 50. Data may be included in the signal. The inner communication system 50 may utilize at least one communication protocol (for example, CAN, LIN, FlexRay, MOST, or Ethernet).

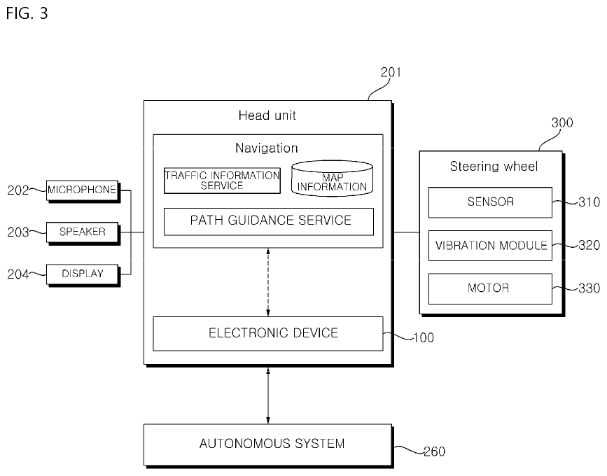

FIG. 3 is a control block diagram of a configuration of a portion of the vehicle according to an embodiment of the present disclosure.

The electronic device 100 may be classified into a lower-level configuration of one of electronic devices included in the vehicle 10. As illustrated in FIG. 3, the electronic device 100 may be classified into a lower-level configuration of a head unit 201. The head unit 201 may be an electronic device implementing the interface device 200 for the vehicle.

The head unit 201 may include a navigation and the electronic device 100. The navigation may include a traffic information service provider, a map provider, and a path guidance service provider.

The head unit 201 may be electrically connected to at least one of a microphone 202, a speaker 203 or a display 204. The electronic device 100 may implement a human machine interface (HMI) with the user, using at least one of the microphone 202, the speaker 203 or the display 204. The microphone 202 may convert a sound into an electrical signal. The speaker 203 may convert an electrical signal into a sound. The display 204 may output visual information based on an electrical signal.

The head unit 201 may be electrically connected to a steering wheel 300. The electronic device 201 may receive a signal, information or data from the steering wheel 300. The head unit 201 may transmit a signal, information or data to the steering wheel 300.

The electronic device 100 may include a user intention determination unit, an autonomous mode control unit, and a steering wheel control unit in terms of functions. The user intention determination unit, the autonomous mode control unit, and the steering wheel control unit may be formed into software blocks and, as such, may be installed in a processor 170. Accordingly, the user intention determination unit, the autonomous mode control unit, and the steering wheel control unit may be classified into lower-level configurations of the processor 170. The user intention determination unit, the autonomous mode control unit, and the steering wheel control unit may be implemented in a middleware or hardware manner.

The user intention determination unit may determine an intention of the user based on a sensing signal generated in a sensor 310. The user intention determination unit may perform operation of step S520 which will be described later.

The autonomous mode control unit may perform switching of a travel mode between a manual mode and an autonomous mode. The autonomous mode control unit may perform operation of step S570 which will be described later.

The steering wheel control unit may cut off operative connection of the steering wheel to steered wheels. The steering wheel control unit may operatively connect the steering wheel and the steered wheels. The steering wheel control unit may position the steering wheel at a normal position where there is no rotation of the steering wheel. The steering wheel control unit may hide at least a portion of the steering wheel into a cockpit module. The steering wheel control unit may expose at least a portion of the hidden steering wheel.

The steering wheel 300 may include a sensor 310, a vibration module 320, and a motor 330.

The sensor 310 may convert force into an electrical signal. The sensor 310 may sense force applied to the steering wheel 300. The sensor 310 may convert sensed force into a sensing signal which is an electrical signal. The sensor 310 may sense force applied to the steering wheel 300 in a direction different from a rotation direction of the steering wheel 300. For example, the sensor 310 may sense force applied to the steering wheel 300 in a forward direction of the vehicle. For example, the sensor 310 may sense force applied to the steering wheel 300 in a rearward direction of the vehicle. For example, the sensor 310 may sense force applied to the steering wheel 300 toward a steering wheel column. For example, the sensor 310 may sense force applied to the steering wheel 300 in a direction opposite to the steering wheel column. For example, the sensor 310 may sense pushing force when viewed with reference to the user seated on a driver seat. For example, the sensor 310 may sense pulling force when viewed with reference to the user seated on the driver seat.

The vibration module 320 may provide vibration to the steering wheel 300. The vibration module 320 may embody an electrical signal as vibration.

The motor 330 may provide force to the steering wheel 300. The motor 330 may convert an electrical signal into physical force. For example, the motor 330 may provide force required to hide at least one of the steering wheel 300 into the cockpit module. For example, the motor 330 may provide force required to expose the hidden steering wheel 300.

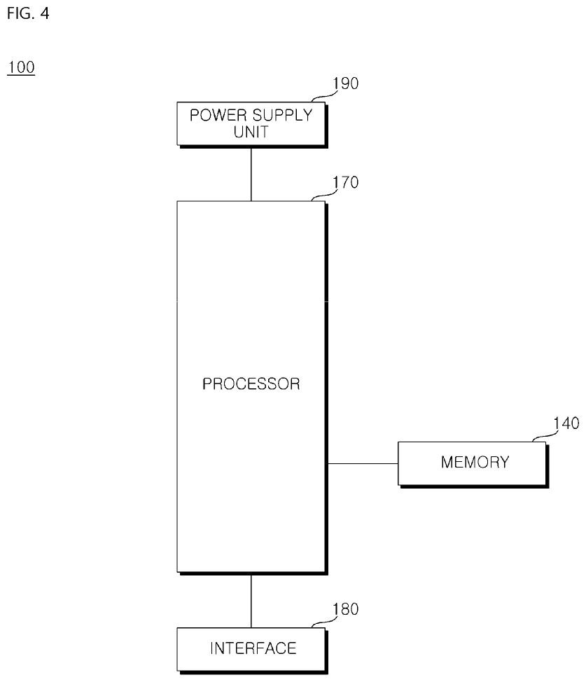

FIG. 4 is a control block diagram of the electronic device according to an embodiment of the present disclosure.

Referring to FIG. 4, the electronic device 100 may include at least one memory 140, at least one processor 170, at least one interface unit 180, and a power supply unit 190.

The memory 140 is electrically connected to the processor 170. The memory 140 may store basic data as to units, control data for unit operation control, and input and output data. The memory 140 may store data processed by the processor 170. The memory 140 may be constituted in a hardware manner by at least one of a read only memory (ROM), a random access memory (RAM), an erasable programmable read-only memory (EPROM), a flash drive, or a hard drive. The memory 140 may store various data for overall operation of the electronic device 100 including a program for processing or controlling the processor 170, etc. The memory 140 may be integrated with the processor 170. In accordance with an embodiment, the memory 140 may be classified into a lower-level configuration of the processor 170.

The interface unit 180 may exchange a signal with at least one electronic device included in the vehicle 10 in a wired or wireless manner. The interface unit 280 may exchange a signal in a wired or wireless manner with at least one of the object detection device 210, the communication device 220, the driving manipulation device 230, the main ECU 240, the vehicle driving device 250, the traveling system 260, the sensing unit 270, or the position data production device 280. The interface unit 280 may be constituted by at least one of a communication module, a terminal, a pin, a cable, a port, a circuit, an element, or a device.

The interface unit 180 may receive a sensing signal from the sensor 310. The interface unit 180 may receive information as to a travel section from the communication device 220. The communication device 220 may receive information as to a section, in which the vehicle 10 currently travels, from an external device through V2X communication. For example, the communication device 220 may receive information as to whether or not the current travel section of the vehicle 10 is an autonomous travel possible section and information as to a residual section for autonomous travel (for example, residual distance information or residual time information). The interface unit 180 may receive information, from the communication device 220, information as to the current travel section of the vehicle 10 received from an external device. The interface unit may receive information as to a user state from the user interface device 200. For example, the interface unit may receive information as to a user state based on a user image photographed by an inner camera of the user interface device 200. The interface unit 180 may receive an electrical signal generated in a user input device from the user interface device 200. For example, the interface unit 180 may receive an electrical signal generated by at least one of a touch input device or a physical input device disposed at the steering wheel.

The power supply unit 190 may supply electric power to the electronic device 100. The power supply unit 190 may receive electric power from a power source (for example, a battery) included in the vehicle 10 and, as such, may supply electric power to each unit of the electronic device 100. The power supply unit 190 may operate in accordance with a control signal supplied from the main ECU 140. The power supply unit 190 may be embodied using a switched-mode power supply (SMPS).

The processor 170 may be electrically connected to the memory 140, the interface unit 280, and the power supply unit 190, and, as such, may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for execution of other functions.

The processor 170 may be driven by electric power supplied from the power supply unit 190. In a state in which electric power from the power supply unit 190 is supplied to the processor 170, the processor 170 may receive data, process the data, generate a signal, and supply the signal.

The processor 170 may receive information from other electronic devices in the vehicle 10 via the interface unit 180. The processor 170 may supply a control signal to other electronic devices in the vehicle 10 via the interface unit 180.

The processor 170 may receive a sensing signal via the interface unit 180. The sensing signal may be generated by force applied to the steering wheel 300 in a direction different from a rotation direction of the steering wheel 300. The sensor 310 may sense force applied to the steering wheel 300 in a direction different from a rotation direction of the steering wheel 300. That is, the sensor 310 may sense force different from force applied to the steering wheel for steering input.

The processor 170 may receive a first sensing signal generated by force applied in a first direction. For example, the first direction may be a direction toward the cockpit module. The first direction may be a forward direction of the vehicle. The first direction may be a direction toward the steering wheel column. The first direction may be a pushing direction of the user by the hand when viewed with reference to the user seated on the driver seat.

The processor 170 may receive a second sensing signal generated by force applied in a second direction different form the first direction. The second direction may be a direction opposite to the first direction. For example, the second direction may be a direction toward a cabin. The second direction may be a rearward direction of the vehicle. The second direction may be a direction opposite to the direction toward the steering wheel column. The second direction may be a pulling direction of the user by the hand when viewed with reference to the user seated on the driver seat.

When a force pushing the steering wheel 300 in a forward direction of the vehicle 10 is sensed through the sensor 310, the processor 170 may switch a travel mode from a manual mode to an autonomous mode. When a force pulling the steering wheel 300 in a rearward direction of the vehicle 10 is sensed through the sensor 310, the processor 170 may switch the travel mode from the autonomous mode to the manual mode.

The processor 170 may provide a control signal for travel mode switching between the manual mode and the autonomous mode based on a sensing signal.

Upon receiving a first sensing signal generated by force applied in the first direction, the processor 170 may provide a first control signal to switch the travel mode from the manual mode to the autonomous mode.

Upon receiving a second sensing signal generated by force applied to the second direction different from the first direction, the processor 170 may provide a second control signal to switch the travel mode from the autonomous mode to the manual mode.

The processor 170 may control operative connection between the steering wheel 300 and the steered wheels and cut-off of the operative connection, based on sensing signals. The steered wheels may be defined as wheels steered to change an advance direction of the vehicle 10 in accordance with rotation of the steering wheel 300. Upon receiving the first sensing signal, the processor 170 may provide a control signal to cut off operative connection between the steering wheel 300 and the steered wheels. Upon receiving the second sensing signal, the processor 170 may provide a control signal to operatively connect the steering wheel 300 and the steered wheels.

The processor 170 may control posture adjustment of the steering wheel based on sensing signals. Upon receiving the first sensing signal, the processor 170 may provide a control signal to position the steering wheel 300 at a normal position where there is no rotation of the steering wheel 300. Upon receiving the second sensing signal, the processor 170 may provide a control signal to adjust posture of the steering wheel 300 such that a steering angle at a time when the second sensing signal is received is reflected.

The processor 170 may control hiding and exposure of the steering wheel based on sensing signals. Upon receiving the first sensing signal, the processor 170 may provide a control signal to hide at least a portion of the steering wheel 300 into the cockpit module. Upon receiving the second sensing signal, the processor 170 may provide a control signal to expose at least a portion of the hidden steering wheel 300. The processor 170 may provide the control signals to the motor (“330” in FIG. 3).

The processor 170 may receive information as to a travel section through the interface unit 180.

Based on information as to a travel section, the processor 170 may determine a residual section for autonomous travel with reference to a point where the vehicle 10 is positioned. For example, when an autonomous travel exclusive road is used, the autonomous travel possible section may mean an autonomous travel exclusive road section. For example, the autonomous travel possible section may mean a section in which communication through the communication device 220 is possible. Upon determining that the residual section for autonomous travel is not greater than a reference distance, the processor may provide the second control signal to switch the travel mode from the autonomous mode to the manual mode.

The processor 170 may control output of an interface providing information in order to provide information to the user. The processor 170 may provide a control signal to output the interface providing information through the speaker 203 and the display 204. The processor 170 may provide the control signal to the user interface device 200. For example, the processor 170 provides the control signal to at least one of the speaker 203 or the display 204. The processor 170 may provide a control signal to output an interface providing information for providing information as to a time when the travel mode is switched from the autonomous mode to the manual mode.

The processor 170 may receive information as to a state of the user through the interface unit 180. Upon determining the state of the user to be a manual travel impossible state, the processor 170 may provide a control signal to park the vehicle 10 in a safe area. The safe area may be an area where the vehicle does not interfere with traveling of other vehicles. The safe area may be an area where collision probability of the vehicle with other vehicles is relatively low. For example, the safe area may be a road shoulder, a rest area, etc. The processor 170 may provide the control signal to at least one of the vehicle driving device 250 or the traveling system 260.

The processor 170 may receive an electrical signal generated in a user input device through the interface unit 180. The user input device may be a physical button or a touchpad provided at the steering wheel. Upon receiving a sensing signal in a state in which an electrical signal from the user input device is received by the processor 170, the processor 170 may provide a control signal to switch the travel mode from the manual mode to the autonomous mode. For example, upon receiving the first sensing signal generated by force applied in the first direction in a state in which an electrical signal from the user input device is received by the processor 170, the processor 170 may provide the first control signal to switch the travel mode from the manual mode to the autonomous mode. For example, upon receiving the second sensing signal generated by force applied in the second direction different from the first direction in a state in which an electrical signal from the user input device is received by the processor 170, the processor 170 may provide the first control signal to switch the travel mode from the autonomous mode to the manual mode. Thus, double user input may be achieved and, as such, malfunction of mode switching may be prevented.

Upon receiving a sensing signal, the processor 170 may provide a control signal to output a user intention identification interface. The processor 170 may provide a control signal to output the user intention identification interface to at least one of the speaker 203 or the display 204. Upon receiving user input to confirm a user intention, the processor 170 may provide a control signal to switch the travel mode between the manual mode and the autonomous mode.

Upon determining that a sensing value based on a sensing signal is not lower than a reference value, the processor 170 may provide the control signal to switch the travel mode between the manual mode and the autonomous mode. For example, upon determining that the sensing value of the first sensing signal generated by force applied in the first direction is not lower than the reference value, the processor 170 may provide the first control signal to switch the travel mode from the manual mode to the autonomous mode. For example, upon determining that the sensing value of the second sensing signal generated by force applied in the second direction different from the first direction is not lower than the reference value, the processor 170 may provide the second control signal to switch the travel mode from the autonomous mode to the manual mode. It may be possible to clearly identify an intention of the user by determining whether force not lower than the reference value is applied to the steering wheel.

Upon continuously receiving a sensing signal for a reference time or more, the processor 170 may provide a control signal to switch the travel mode between the manual mode and the autonomous mode. For example, upon receiving the first sensing signal generated by force applied in the first direction for the reference time or more, the processor 170 may provide the first control signal to switch the travel mode from the manual mode to the autonomous mode. For example, upon receiving the second sensing signal generated by force applied in the second direction different from the first direction for the reference time or more, the processor 170 may provide the second control signal to switch the travel mode from the autonomous mode to the manual mode. It may be possible to clearly identify an intention of the user by determining whether or not force is applied to the steering wheel for the reference time or more.

An exposed state of the steering wheel 300 may be one of a first state and a second state. The first state may be a state in which the steering wheel is closer to the cockpit module than in the second state.

When the steering wheel 300 is in the first state, the vehicle 10 may travel in a semi-autonomous mode. When force is applied in the first direction to the steering wheel 300 in the first state, the travel mode may be switched to a fully autonomous mode. Upon receiving the first sensing signal generated by force applied to the steering wheel in the first state, the processor 170 may provide a first control signal to switch the travel mode to the fully autonomous mode. When force is applied in the second direction to the steering wheel 300 in the first state, the travel mode may be switched to the manual mode.

When the steering wheel 300 is in the second state, the vehicle 10 may travel in the manual mode. The steering wheel 300 in the second state may receive a rotation input for steering of the user. When force is applied in the first direction to the steering wheel 300 in the second state, the travel mode may be switched to the semi-autonomous mode. Upon receiving the second sensing signal generated by force applied to the steering wheel in the second state, the processor 170 may provide a second control signal to switch the travel mode to the semi-autonomous mode.

The semi-autonomous mode may be defined by autonomous travel in a state in which the user partially intervenes in the autonomous travel. The semi-autonomous mode may be explained as a travel control mode in which a majority of travel control is assigned to the traveling system 260, but driving manipulation of the user through the driving manipulation device 230 is reflected in traveling. For example, when user input associated with at least one of acceleration, speed reduction, or steering is generated by the driving manipulation device 230 in a state in which travelling is carried out by the traveling system 260 in the semi-autonomous mode, the user input may be reflected in the traveling. The semi-autonomous mode may be referred to as an “incompletely autonomous mode”.

The fully autonomous mode may be defined as autonomous travel in a state in which there is no intervention of user in the autonomous travel.

The processor 170 may receive information as to a travel section through the interface unit 180. Upon determining that the residual section for autonomous travel at a time when a sensing signal is received by the processor 170 is not greater than a reference distance, the processor 170 may provide a control signal to output an interface rejecting an autonomous mode switching. The interface rejecting an autonomous mode switching may include information as to reasons for rejection.

When the steering wheel 300 is in the first state, the processor 170 may determine whether or not the residual section for autonomous travel is not greater than the reference distance. The first state may be explained as a state in which the steering wheel 300 is closer to the cockpit module than in the state of the steering wheel 300 in the manual mode.

The processor 170 may provide a control signal to output an interface providing information for providing information as to a time when the travel mode is switched from the manual mode to the autonomous mode. The interface providing information to provide information as to the time when the travel mode is switched from the manual mode to the autonomous mode may be implemented in the form of a countdown for a switching time.

The electronic device 100 may include at least one printed circuit board (PCB). The memory 140, the interface unit 180, the power supply unit 190 and the processor 170 may be electrically connected to the printed circuit board.

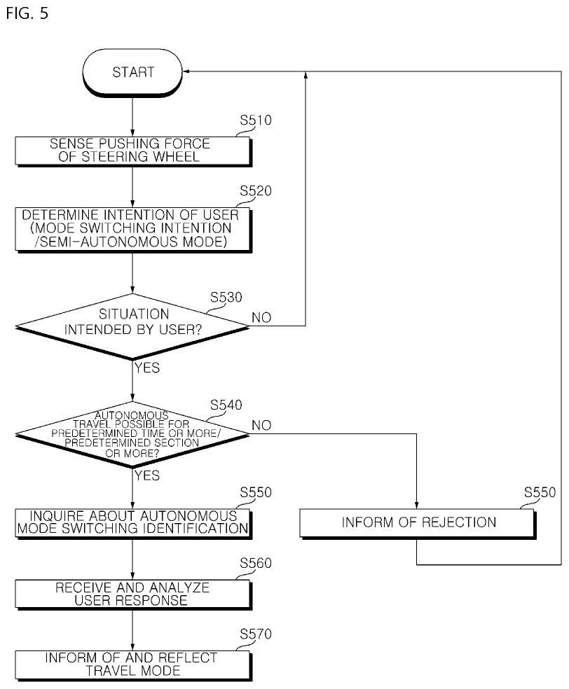

FIG. 5 is a flowchart of the electronic device according to an embodiment of the present disclosure.

Referring to FIG. 5, the processor 170 may sense pushing force of the steering wheel (S510). The processor 170 may receive a sensing signal generated by force applied to the steering wheel 400 in a direction different from a rotation direction of the steering wheel 300.

The processor 170 may determine an intention of the user as to mode switching (S520). For example, upon receiving a sensing signal in a state in which an electrical signal from a user input device is received by the processor 170, the processor 170 may provide a control signal to switch a travel mode between a manual mode and an autonomous mode. For example, upon determining that a sensing value based on the sensing signal is not lower than a reference value, the processor 170 may provide the control signal to switch the travel mode between the manual mode and the autonomous mode. For example, upon continuously receiving the sensing signal for a reference time or more, the processor 170 may provide a control signal to switch the travel mode between the manual mode and the autonomous mode.

The processor 170 may determine whether or not autonomous travel is possible for a predetermined time or more or in a predetermined section or more (S540). Based on information as to a travel section, the processor 170 may determine a residual section for autonomous travel with reference to a point where the vehicle 10 is positioned. Upon determining that the residual section for autonomous travel is not greater than a reference distance at a time when a sensing signal is received, the processor 170 may provide a control signal to output an interface rejecting an autonomous mode switching (S545).

Upon determining that autonomous travel is possible for a predetermined time or more or in a predetermined section or more, the processor 170 may inquire the user about autonomous mode switching identification (S550). The processor 170 may then receive a user response and analyze the received user response (S560). For example, upon receiving a sensing signal, the processor 170 may provide a control signal to output a user intention identification interface. Upon receiving a user response corresponding to the user intention identification interface in this case, the processor 170 may provide a control signal to switch the travel mode between the manual mode and the autonomous mode.

The processor 1760 may inform of travel mode switching, and may switch the travel mode from the manual mode to the autonomous mode (S570). Based on a sensing signal, the processor 170 may provide a control signal to switch the travel mode between the manual mode and the autonomous mode. Upon receiving a first sensing signal generated by force applied in a first direction, the processor 170 may provide a first control signal to switch the travel mode from the manual mode to the autonomous mode. Thereafter, the processor 170 may perform subsequent operations as follows. Upon receiving the first sensing signal, the processor may provide a control signal to cut off operative connection between the steering wheel 300 and the steered wheels. Upon receiving the first sensing signal, the processor 170 may provide a control signal to position the steering wheel 300 at a normal position where there is no rotation of the steering wheel 300. Upon receiving the first sensing signal, the processor 170 may provide a control signal to hide at least a portion of the steering wheel 300 into the cockpit module.

In the following description, operation of the electronic device 100 may be understood as operation of the processor 170, unless expressly stated otherwise.

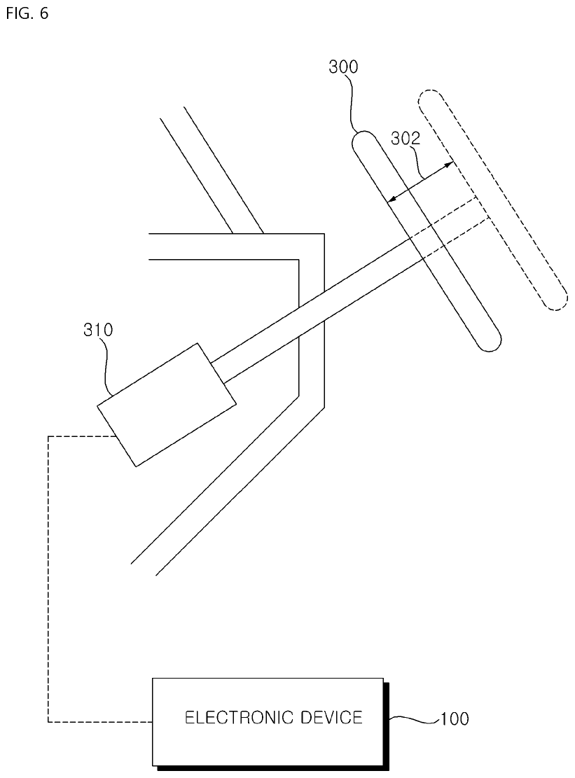

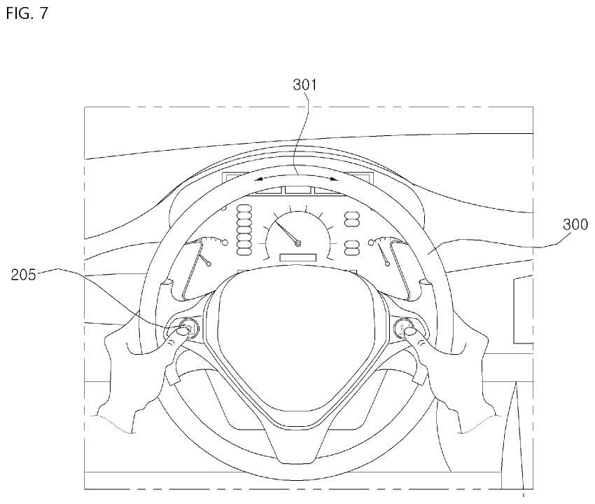

FIGS. 6 and 7 are views schematically illustrating the electronic device and the steering wheel according to an embodiment of the present disclosure.

Referring to the figures, the sensor 310 may sense force of the user pushing and pulling the steering wheel 300.

The sensor 310 may sense force applied to the steering wheel 300 in a direction 302 different from a rotation direction 301 of the steering wheel 300.

The sensor 310 may generate a sensing signal based on the sensed force. Upon sensing force applied to the steering wheel 300 in a first direction, the sensor 310 may generate a first sensing signal. For example, the first direction may be a direction toward the cockpit module. The first direction may be a forward direction of the vehicle. The first direction may be a direction toward the steering wheel column. The first direction may be a pushing direction of the user by the hand when viewed with reference to the user seated on the driver seat. Upon sensing force applied to the steering wheel 300 in a second direction different from the first direction, the sensor 310 may generate a second signal. The second direction may be a direction opposite to the first direction. For example, the second direction may be a direction toward the cabin. The second direction may be a rearward direction of the vehicle. The second direction may be a direction opposite to the direction toward the steering wheel column. The second direction may be a pulling direction of the user by the hand when viewed with reference to the user seated on the driver seat.

The electronic device 100 may receive a sensing signal from the sensor 310. Based on the received sensing signal, the electronic device 100 may provide a control signal to switch a travel mode between a manual mode and an autonomous mode.

Upon sensing force pushing the steering wheel 300 in the forward direction of the vehicle 10 through the sensor 310, the electronic device 100 may switch the travel mode from the manual mode to the autonomous mode. Upon receiving the first sensing signal generated by force applied in the first direction, the processor 170 may provide a first control signal to switch the travel mode from the manual mode to the autonomous mode.

Upon sensing force pulling the steering wheel 300 in the rearward direction of the vehicle 10 through the sensor 310, the processor 170 may switch the travel mode from the autonomous mode to the manual mode. Upon receiving the second sensing signal generated by force applied in the second direction different from the first direction, the processor 170 may provide a second control signal to switch the travel mode from the autonomous mode to the manual mode.

The user may push or pull the steering wheel 300 in a state of applying user input through the input device 205 provided at the steering wheel 300. In this case, the input device 205 may receive the user input, and the sensor 310 may sense force applied to the steering wheel 300 in the direction 302 different from the rotation direction 301. The input device 205 may convert the user input into an electrical signal, and the sensor 301 may generate a sensing signal based on the sensed force. The electronic device 1090 may receive the sensing signal from the sensor 310 in a state of receiving the electrical signal from the user input device 20-5. In this case, the electronic device 100 may provide a control signal to switch the travel mode between the manual mode and the autonomous mode. For example, upon receiving the first sensing signal generated by force applied in the first direction in a state in which the electrical signal from the input device 205 is received by the electronic device 100, the electronic device 100 may provide the first control signal to switch the travel mode from the manual mode to the autonomous mode. For example, upon receiving the second sensing signal generated by force applied in the second direction in a state in which the electrical signal from the input device 205 is received by the electronic device 100, the electronic device 100 may provide the second control signal to switch the travel mode from the autonomous mode to the manual mode.

Thus, double user input may be achieved and, as such, malfunction of mode switching may be prevented.

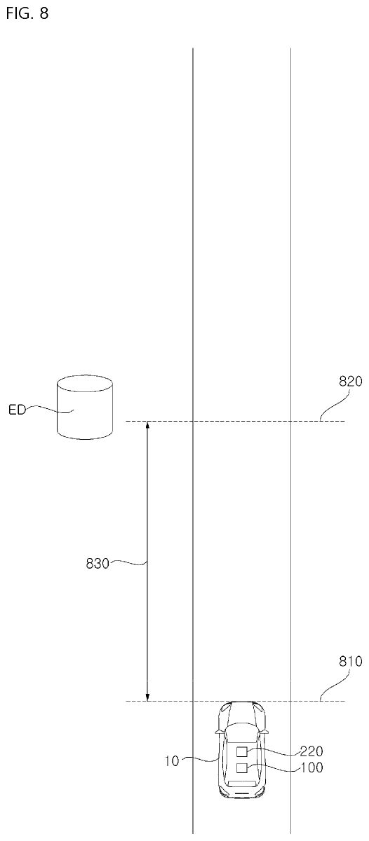

FIG. 8 is a view schematically illustrating the vehicle, which currently travels, in accordance with an embodiment of the present disclosure.

Referring to FIG. 8, the communication device 220 may receive information as to a current travel section or a predetermined travel section from an external device ED. The communication device 220 may receive information through 5G V2X. The external device ED may be a management server. The electronic device 100 may receive information as to the current travel section or the predetermined travel section from the communication device 220 through the interface unit 180.

In a state in which the vehicle 10 is positioned at a first point 810, the communication device 220 may receive information as to an autonomous travel possible section. The communication device 220 may receive information as to a residual section for autonomous travel 830. The electronic device 100 may receive information as to the residual section for autonomous travel 830 from the communication device 220 through the interface unit 180. The communication device 220 may receive information as to a residual time for which the vehicle can travel in the autonomous travel possible section 830. The electronic device 100 may receive information as to a residual time, for which the vehicle can travel in the autonomous travel possible section 830, from the communication device 220 through the interface unit 180.

The electronic device 100 may determine whether or not the residual section for autonomous travel 830 is not greater than a predetermined distance. Upon determining that the residual section for autonomous travel is not greater than the predetermined distance at a time when the first sensing signal is received, the electronic device 100 may reject travel mode switching to the autonomous mode. Upon determining that the residual section for autonomous travel is not greater than the predetermined distance in a state in which the vehicle 10 travels in the autonomous mode, the electronic device 100 may provide a control signal to switch the travel mode from the autonomous mode to the manual mode.

The electronic device 100 may determine whether or not a residual time for which the vehicle can travel in the autonomous travel possible section 830 is not greater than a reference time. Upon determining that the residual time for which the vehicle can travel in the residual section for autonomous travel 830 is not greater than the reference time, at a time when the first sensing signal is received, the electronic device 100 may reject travel mode switching to the autonomous mode. Upon determining that the residual time for which the vehicle can travel in the residual section for autonomous travel 830 is not greater than the reference time in a state in which the vehicle 10 travels in the autonomous vehicle, the electronic device 100 may provide a control signal to switch the travel mode from the autonomous mode to the manual mode.

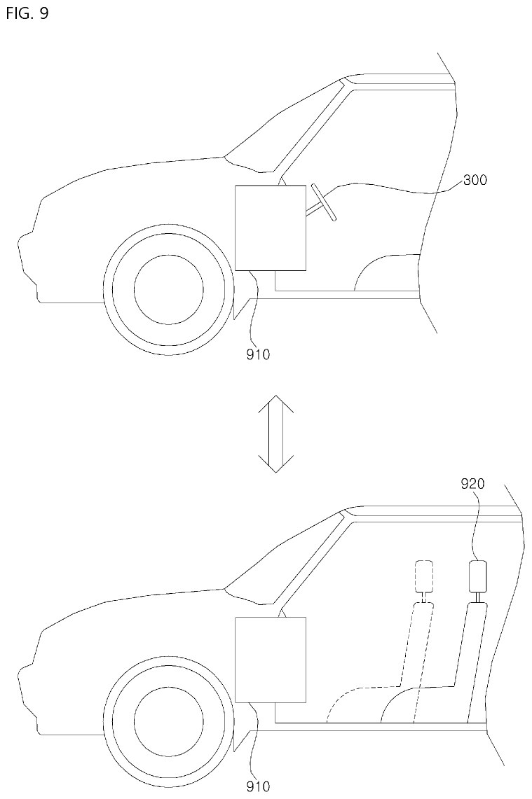

FIG. 9 is a view schematically illustrating a portion of the vehicle according to an embodiment of the present disclosure.

Referring to FIG. 9, the electronic device 100 may control posture adjustment of the steering wheel 300 based on a sensing signal. The electronic device 100 may control hiding and exposure of the steering wheel 300 based on a sensing signal. The electronic device 100 may control the position and posture of a driver seat 920 based on a sensing signal.

Upon receiving a first sensing signal, the electronic device 100 may provide a control signal to position the steering wheel 300 at a normal position where there is no rotation of the steering wheel 300. Upon receiving the first sensing signal, the electronic device 100 may provide a control signal to hide at least a portion of the steering wheel 300 into the cockpit module 910. Upon receiving the first sensing signal, the electronic device 100 may provide a control signal to move the driver seat 920 rearwards. Upon receiving the first sensing signal, the electronic device 100 may provide a control signal to rotate the driver seat 920. The vehicle 10 may include a seat driving device for adjusting the position and posture of the driver seat 920. The electronic device 100 may provide, to the seat driving device, a signal to control the position and posture of the driver seat 920.

Upon receiving a second sensing signal, the electronic device 100 may provide a control signal to control posture adjustment of the steering wheel 300 in order to reflect a steering angle at a time when the sensing signal is received. Upon receiving the second sensing signal, the electronic device 100 may provide a control signal to expose at least a portion of the steering wheel 300 which is in a hidden state. Upon receiving the second sensing signal, the electronic device 100 may provide a control signal to move the driver seat 920 forwards. Upon receiving the second sensing signal, the electronic device 100 may provide a control signal to rotate the driver seat 920. The electronic device 100 may provide, to the seat driving device, a signal to control the position and posture of the driver seat 920.

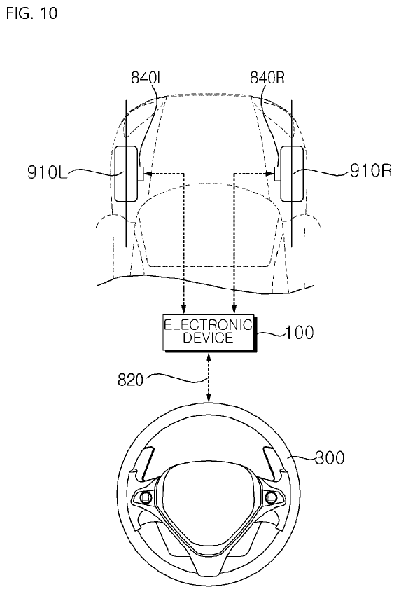

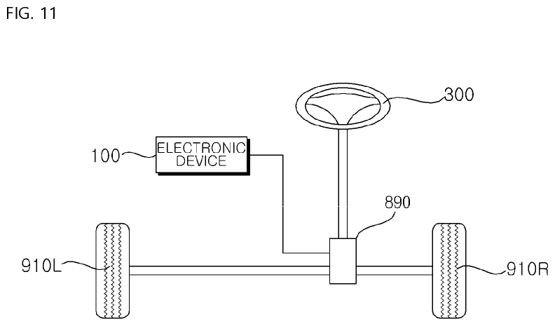

FIGS. 10 and 11 are views referred to for explanation of operative connection between the steering wheel 300 and steered wheels 910L and 910R and cut-off of the operative connection.

FIG. 10 illustrates electrical operative connection between the steering wheel 300 and the steered wheels 910L and 910R and cut-off of the electrical operative connection. FIG. 11 illustrates mechanical operative connection between the steering wheel 300 and the steered wheels 910L and 910R and cut-off of the mechanical operative connection.

Referring to FIG. 10, the electronic device 100 may provide a control signal to cut off electrical operative connection between the steering wheel 300 and the steered wheels 910L and 910R upon receiving a first sensing signal. Upon receiving the control signal to cut off electrical operative connection between the steering wheel 300 and the steered wheels 910L and 910R from the electronic device 100, the steering wheel 300 and the steered wheels 910L and 910R may cut off electrical operative connection therebetween. In this case, the steering wheel 300 does not rotate even when the direction of the steered wheels 910L and 910R is varied. In addition, the direction of the steered wheels 910L and 910R is not varied even when the steering wheel 300 rotates.

Upon receiving a second sensing signal, the processor 170 may provide a control signal to electrically operatively connect the steering wheel 300 and the steered wheels 910L and 910R. Upon receiving an operative connection control signal from the electronic device 100, the steering wheel 300 and the steered wheels 910L and 910R may be operatively connected. In this case, when the direction of the steered wheels 910L and 910R is varied, the steering wheel 300 is rotated. In addition, when the steering wheel 300 rotates, the direction of the steered wheels 910L and 910R is varied.

In accordance with determination as to reliability of the autonomous mode, the electronic device 100 may provide a control signal to operatively connect the steering wheel 300 and the steered wheels 910L and 910R. Upon determining that reliability of the autonomous mode is not higher than a reference value, the processor 170 may provide a control signal to operatively connect the steering wheels and the steered wheels. Upon receiving the control signal for operative connection from the electronic device 100, the steering wheel 300 and the steered wheels 910L and 910R may be electrically connected. In this case, when the direction of the steered wheels 910L and 910R is varied, the steering wheel 300 is rotated. In addition, when the steering wheel 300 rotates, the direction of the steered wheels 910L and 910R is varied. Reliability of the autonomous mode may be defined as a probability that no accident occurs during travel in the autonomous mode. In accordance with whether the probability that no accident occurs is not lower than a reference value or is lower than the reference value, the processor 170 may determine reliability of the autonomous mode to be high or low. High reliability of the autonomous mode may be explained as a continuous autonomous travel possible state, whereas low reliability of the autonomous mode may be explained as a continuous autonomous travel impossible state.

Referring to FIG. 11, the steering wheel 300 may be mechanically operatively connected to the steered wheels 910L and 910R.

For example, the steering wheel 300 may be mechanically connected to the steered wheels 910L and 910R under the condition that a steering shaft, a steering gear box, a Pitman arm, a drag link, a center link, a tie-rod, a knuckle arm, a steering knuckle, a king pin, etc. are interposed between the steering wheel 300 and the steered wheels 910L and 910R. In this case, each unit interposed between the steering wheel 300 and the steered wheels 910L and 910R may be omitted or added in accordance with an embodiment.

Meanwhile, the vehicle 10 may further include a clutch 890. In this case, the clutch 890 may perform or cut off transmission of power from the steering wheel 300 to the steered wheels 910L and 910R under control of the electronic device 100.

Upon receiving a first sensing signal, the electronic device 100 may provide a control signal to cut off mechanical operative connection between the steering wheel 300 and the steered wheels 910L and 910R. When the clutch 890 receives a signal based on the control signal to cut off the operative connection, the steering wheel 300 and the steered wheels 910L and 910R may cut off mechanical operative connection therebetween. In this case, even when the direction of the steered wheels 910L and 910R is varied, the steering wheel 300 is not rotated. In addition, even when the steering wheel 300 rotates, the direction of the steered wheels 910L and 910R is not varied.

Upon receiving a second sensing signal, the processor 170 may provide a control signal to mechanically operatively connect the steering wheel 300 and the steered wheels 910L and 910R. When the clutch 890 receives a control signal to achieve the operative connection, the steering wheel 300 and the steered wheels 910L and 910R may be mechanically connected. In this case, when the direction of the steered wheels 910L and 910R is varied, the steering wheel 300 is rotated. In addition, when the steering wheel 300 rotates, the direction of the steered wheels 910L and 910R is varied.

In accordance with determination as to reliability of the autonomous mode, the electronic device 100 may provide a control signal to mechanically operatively connect the steering wheel 300 and the steered wheels 910L and 910R. When the clutch 890 receives a signal based on a control signal for operative connection, the steering wheel 300 and the steered wheels 910L and 910R may be mechanically connected. In this case, when the direction of the steered wheels 910L and 910R is varied, the steering wheel 300 is rotated. In addition, when the steering wheel 300 rotates, the direction of the steered wheels 910L and 910R is varied.

On the other hand, when operative connection between the steering wheel 300 and the steered wheels 910L and 910R is cut off, the vehicle interface device 200 may provide an interface for a game, and an interface for driving practice simulation. In this case, the user may play a game or may perform a driving practice, using the steering wheel 300.

Meanwhile, although operative connection between the steering wheel 300 and the steered wheels 910L and 910R is basically cut off in the autonomous mode of the vehicle 10, the operative connection may be maintained in a specific situation. Even when the vehicle 10 is in the autonomous mode, the processor 170 may provide a control signal to maintain operative connection between the steering wheel 300 and the steered wheels 910L and 910R in a specific situation. For example, the processor 170 may provide a control signal to maintain operative connection between the steering wheel 300 and the steered wheels 910L and 910R for a predetermined time in an initial stage of entrance of the autonomous mode or just before release of the autonomous mode. For example, the processor 170 may provide a control signal to maintain operative connection between the steering wheel 300 and the steered wheels 910L and 910R in a situation in which reliability of the autonomous mode is uncertain. For example, when the vehicle 10 travels in a frequent accident occurrence section or an accident occurrence section, the processor 170 may provide a control signal to maintain operative connection between the steering wheel 300 and the steered wheels 910L and 910R.

Meanwhile, even in a state in which operative connection between the steering wheel 300 and the steered wheels 910L and 910R is cut off in the autonomous mode of the vehicle 10, cooperative control with the user may be possible. For example, when an emergency situation occurs under the condition that the attention state of the user is normal, the processor 170 may provide a steering wheel manipulation value of the user to at least one electronic device included in the vehicle 10 (for example, the main ECU 240, the vehicle driving device 250, and the traveling system 260), irrespective of whether or not the steering wheel 300 and the steered wheels 910L and 910R are operatively connected. The emergency situation may be determined by the processor 170 based on at least one of time to collision (TTC), time headway (THW), whether or not an accident occurs, or whether or not system failure occurs. For example, when reliability of the autonomous mode is enhanced from low to high, the processor 170 may provide a steering wheel manipulation value of the user to at least one electronic device included in the vehicle 10 (for example, the main ECU 240, the vehicle driving device 250, and the traveling system 260), irrespective of whether or not the steering wheel 300 and the steered wheels 910L and 910R are operatively connected.

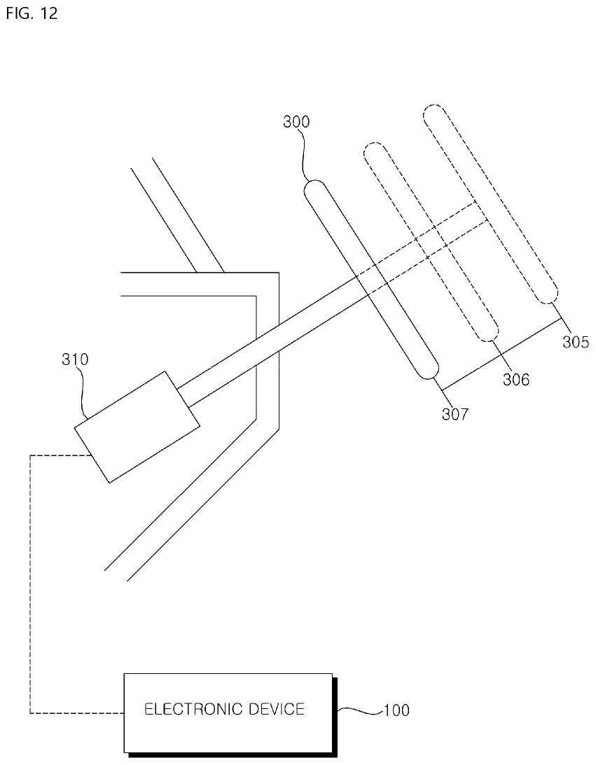

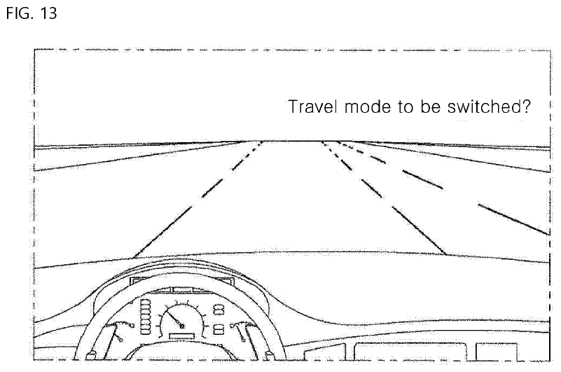

FIGS. 12 and 13 are views referred to for explanation of travel mode switching according to an embodiment of the present disclosure.

Referring to the figures, when the user applies force in a first direction, the steering wheel 300 may move in a stepwise manner such that movement of the steering wheel 300 is divided into a first step and a second step, in order to identify a travel mode switching intention or whether or not travel mode switching is possible.

In FIG. 12, reference numeral “305” designates a state of the steering wheel 300 in the manual mode. Reference numeral “306” designates a state of the steering wheel 300 in the first step. Reference numeral “307” designates a state of the steering wheel 300 in the second step. Reference numeral “307” may also be understood as designating a state of the steering wheel 300 in the autonomous mode.

The first step may be a step of identifying a travel mode switching intention or a travel mode switching possibility.

For example, when it is determined that force is applied in a first direction at a predetermined value or more or for a predetermined time or more in a manual mode state, the first step may start. In this case, the electronic device 100 may identify whether or not there is travel mode switching. For example, as illustrated in FIG. 13, the electronic device 100 may inquire the user about whether or not there is a travel mode switching intention.

For example, when it is determined that force is applied in a first direction at a predetermined value or more or for a predetermined time or more, the first step may start. In this case, the electronic device 100 may determine whether or not the current state is an autonomous travel possible state. For example, the electronic device 100 may determine whether or not the current state is an autonomous travel possible state, based on whether or not reliability of a sensor included in the object detection device 200 is not higher than a reference value, and whether or not the current travel road is an autonomous travel possible road.

The second step may be a step in which the vehicle travels in the autonomous mode. When it is determined that force is applied in a first direction at a predetermined value or more or for a predetermined time or more under the condition that a travel mode switching intention of the user is identified, and a travel mode switching possible state is determined in the first step state, the electronic device 100 may switch the travel mode to the autonomous mode.

Upon sensing force in the first direction in the manual mode state 305, the electronic device 100 may enter the first step 306. In the state of the first step 306, the electronic device 100 may output an interface to identify whether or not there is an intention to switch the travel mode to the autonomous mode. In the first step 306, the electronic device 100 may determine whether or not the state of the vehicle 10 is an autonomous travel possible state. The user may identify the output interface to identify an intention to switch the travel mode to the autonomous mode, and may then apply force in the first direction once more.

Upon sensing force applied in the first direction once more in the first step 306, the electronic device 100 may enter the second step 307. In the state of the second step 307, the electronic device 100 may switch the travel mode to the autonomous mode.

The processor 170 may provide a control signal to switch the travel mode between the manual mode and the autonomous mode based on a sensing signal.

The processor 170 may provide a control signal to switch the travel mode between the manual mode and the autonomous mode through 5G V2X. In this case, the processor 170 may inquire a 5G server about whether or not travel mode switching is possible, thereby performing travel mode switching. Upon switching the travel mode to the autonomous mode, the processor 170 may receive a control message through the 5G server, thereby controlling the vehicle.

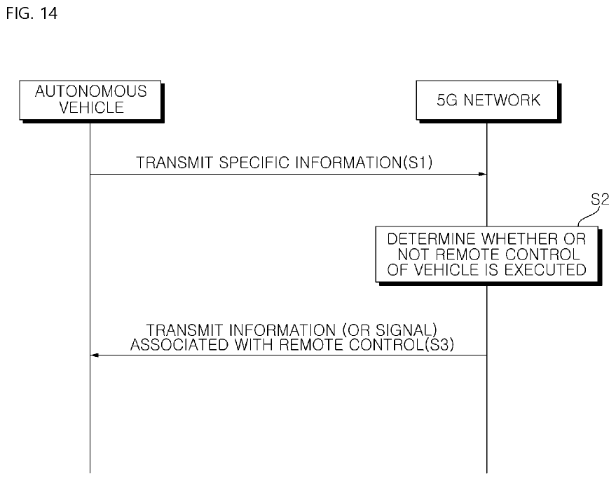

FIG. 14 illustrates an example of basic operations of an autonomous vehicle and a 5G network in a 5G communication system.

The autonomous vehicle 10 transmits specific information to the 5G network (S1).

The specific information may include information associated with autonomous travel.

The autonomous travel-associated information may be information directly associated with control for traveling of the vehicle 10. For example, the autonomous travel-associated information may include at least one of object data indicating an object around the vehicle, map data, vehicle state data, vehicle position data, or driving plan data.

The autonomous travel-associated information may further include service information required for autonomous travel, etc. For example, the service information may include information input through a user terminal as to a destination and a safety grade of the vehicle 10. In addition, the 5G network may determine whether or not remote control of the vehicle 10 is executed (S2).

In this case, the 5G network may include a server or a module for executing remote control associated with autonomous travel.

In addition, the 5G network may transmit information (or a signal) associated with remote control to the autonomous vehicle 10 (S3). For example, the 5G network may transmit, to the autonomous vehicle 10, a signal as to whether or not travel mode switching is possible.

As described above, the information associated with the remote control may be a signal directly applied to the autonomous vehicle 10, and may further include service information required for autonomous travel. In an embodiment of the present disclosure, the autonomous vehicle 10 may provide services associated with autonomous travel by receiving service information such as information as to section-based insurance and a dangerous section selected on a travel path through a server connected to the 5G network.

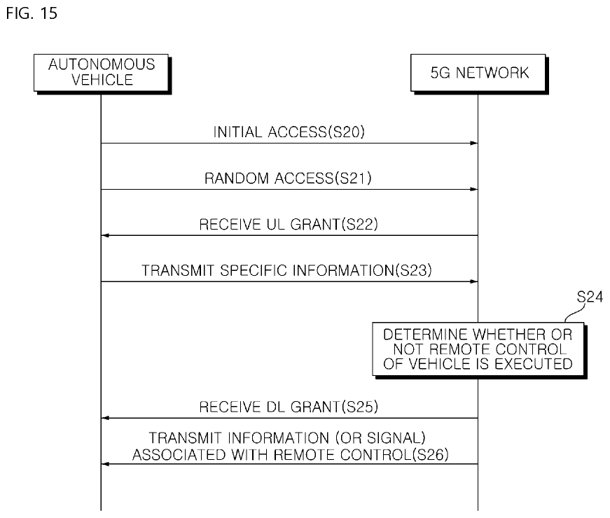

Hereinafter, essential procedures for 5G communication between the autonomous vehicle 10 and the 5G network (for example, a procedure of initial access between the vehicle and the 5G network, etc.) will be briefly described with reference to FIGS. 15 to 19, in order to provide insurance services applicable on a section basis in an autonomous travel procedure in accordance with an embodiment of the present disclosure.

FIG. 15 illustrates an example of application operations of the autonomous vehicle 10 and the 5G network in the 5G communication system.

The autonomous vehicle 10 performs a procedure of initial access to the 5G network (S20).

The initial access procedure includes a cell search procedure for acquiring a downlink (DL) operation, a procedure for acquiring system information, etc.

In addition, the autonomous vehicle 10 performs a procedure of random access to the 5G network (S21).

The random access procedure includes a preamble transmission procedure for uplink (UL) synchronization acquisition or UL data transmission, a random access response reception procedure, etc.

In addition, the 5G network transmits, to the autonomous vehicle 10, a UL grant for scheduling transmission of specific information (S22).

The UL grant reception may include a procedure of receiving time/frequency resource scheduling in order to transmit UL data to the 5G network.

In addition, the autonomous vehicle 10 transmits specific information to the 5G network based on the UL grant (S23).

The 5G network then determines whether or not remote control of the vehicle 10 is executed (S24).

The autonomous vehicle 10 then receives a DL grant through a downlink control channel in order to receive a response to the specific information from the 5G network (S25).

The 5G network then transmits information (or a signal) associated with remote control to the autonomous vehicle 10 based on the DL grant (S26).

Meanwhile, although an example, in which the procedures of initial access and random access of the autonomous vehicle 10 to the 5G communication network and the procedure of receiving a DL grant are combined, has been illustratively described with reference to FIG. 15 through procedures of S20 to S26, the present disclosure is not limited thereto.

For example, the initial access procedure and/or the random access procedure may be executed through steps S20, S22, S23, S24, and S26. In addition, the initial access procedure and/or the random access procedure may be executed through, for example, steps S21, S22, S23, S24, and S26. In addition, a procedure of combining the AI operation and the downlink grant reception procedure may be executed through steps S23, S24, S25, and S26.

In addition, although operation of the autonomous vehicle 10 has been illustratively described with reference to FIG. 15 through steps S20 to S26, the present disclosure is not limited thereto.

For example, operation of the autonomous vehicle 10 may be carried out through selective combination of steps S20, S21, S22, and S25 with steps S23 and S26. In addition, for example, operation of the autonomous vehicle 10 may be constituted by steps S21, S22, S23, and S26. In addition, for example, operation of the autonomous vehicle 10 may be constituted by steps S20, S21, S23, and S26. In addition, for example, operation of the autonomous vehicle 10 may be constituted by steps S22, S23, S25, and S26.

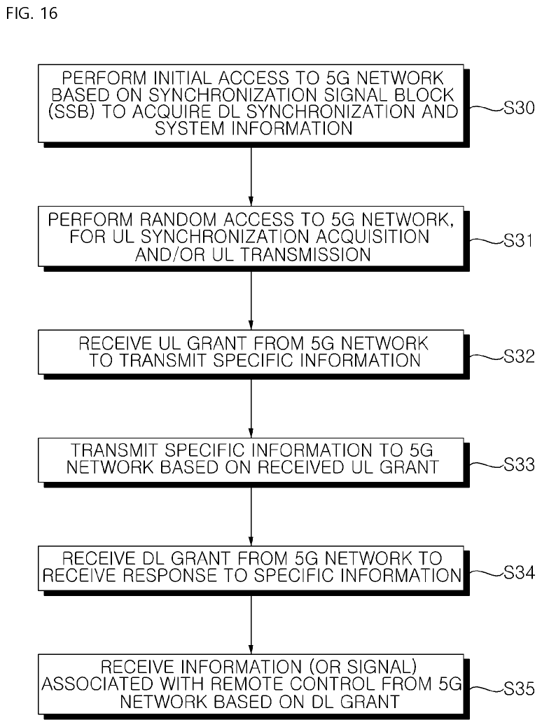

Referring to FIG. 16, the autonomous vehicle 10, which includes an autonomous module, first performs a procedure of initial access to the 5G network based on a synchronization signal block (SSB) in order to acquire DL synchronization and system information (S30).

In addition, the autonomous vehicle 10 performs a procedure of random access to the 5G network, for UL synchronization acquisition and/or UL transmission (S31).

In addition, the autonomous vehicle 10 receives a UL grant from the 5G network in order to transmit specific information (S32).

In addition, the autonomous vehicle 10 transmits the specific information to the 5G network based on the UL grant (S33).

In addition, the autonomous vehicle 10 receives a DL grant from the 5G network in order to receive a response to the specific information (S34).

In addition, the autonomous vehicle 10 receives information (or a signal) associated with remote control from the 5G network based on the DL grant (S35).

A beam management (BM) procedure may be added to step S30. A beam failure recovery procedure associated with transmission of a physical random access channel (PRACH) may be added to step S31. A quasi-co-location (QCL) relation may be added to step S32 in association with a beam reception direction of a physical downlink control channel (PDCCH) including a UL grant. A QCL relation may be added to step S33 in association with a beam transmission direction of a physical uplink control channel (PUCCH)/physical uplink shared channel (PUSCH) including specific information. In addition, a QCL relation may be added to step S34 in association with a beam reception direction of a PDCCH including a DL grant.

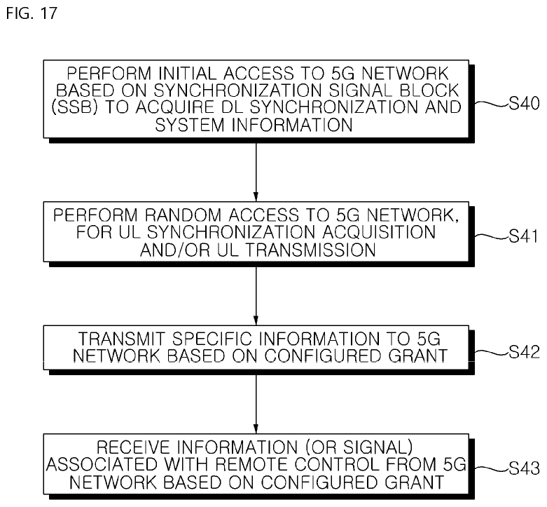

Referring to FIG. 17, the autonomous vehicle 10 performs a procedure of initial access to a 5G network based on an SSB in order to acquire DL synchronization and system information (S40).

In addition, the autonomous vehicle 10 performs a procedure of random access to the 5G network, for UL synchronization acquisition and/or UL transmission (S41).

In addition, the autonomous vehicle 10 transmits specific information to the 5G network based on a configured grant (S42). Transmission of the specific information based on the configured grant carried out in place of the procedure of performing reception of a UL grant from the 5G network will be described in more detail in paragraph H.

In addition, the autonomous vehicle 10 receives information (or a signal) associated with remote control from the 5G network based on the configured grant (S43).

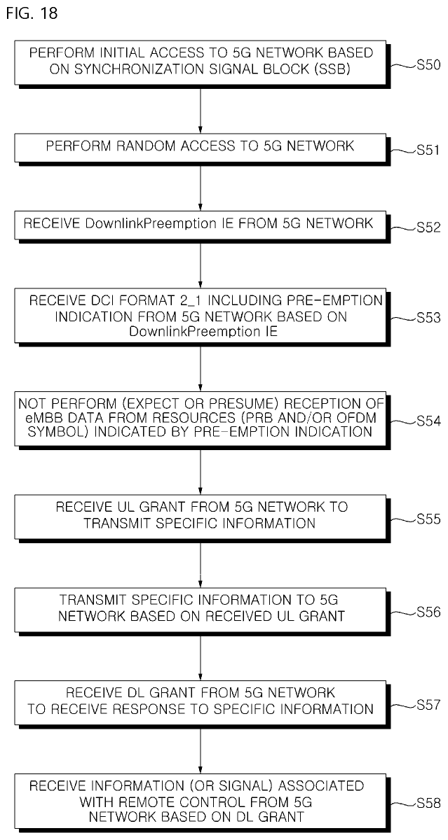

Referring to FIG. 18, the autonomous vehicle 10 performs a procedure of initial access to the 5G network based on an SSB in order to acquire DL synchronization and system information (S50).

In addition, the autonomous vehicle 10 performs a procedure of random access to the 5G network, for UL synchronization acquisition and/or UL transmission (S51).

In addition, the autonomous vehicle 10 may receive a DownlinkPreemption IE from the 5G network (S52).

In addition, the autonomous vehicle 10 receives a downlink control information (DCI) format 2_1 including a preemption indication from the 5G network based on the DownlinkPreemption IE (S53).

In addition, the autonomous vehicle 10 does not perform (expect or presume) reception of enhanced mobile broadband (eMBB) data from resources (physical resource block (PRB) symbols and/or orthogonal frequency division multiplexing (OFDM) symbols) indicated by the preemption indication (S54).

Operation associated with the preemption instruction will be described in more detail in paragraph J.

In addition, the autonomous vehicle 10 receives a UL grant from the 5G network in order to transmit specific information (S55).

In addition, the autonomous vehicle 10 transmits the specific information to the 5G network based on the UL grant (S56).

In addition, the autonomous vehicle 10 receives a DL grant from the 5G network in order to receive a response to the specific information (S57).

In addition, the autonomous vehicle 10 receives information (or a signal) associated with remote control from the 5G network based on the DL grant (S58).

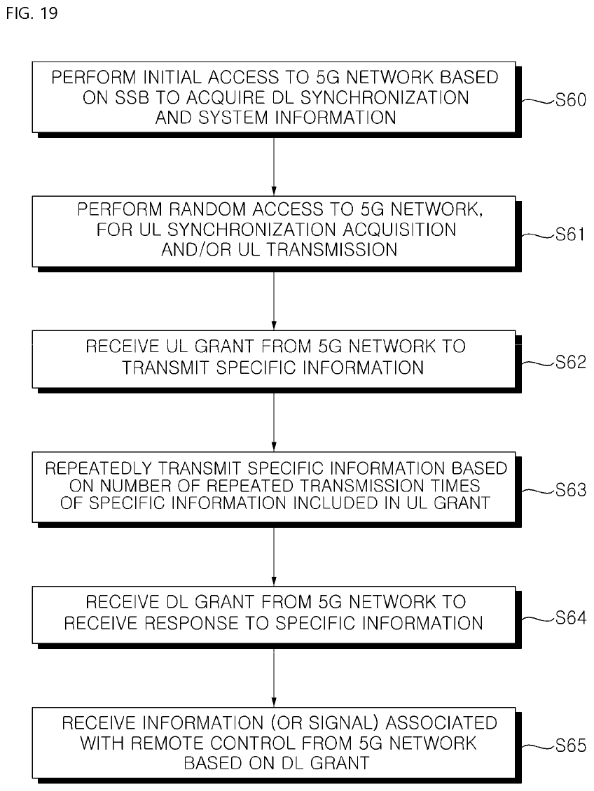

Referring to FIG. 19, the autonomous vehicle 10 performs a procedure of initial access to the 5G network based on an SSB in order to acquire DL synchronization and system information (S60).

In addition, the autonomous vehicle 10 performs a procedure of random access to the 5G network, for UL synchronization acquisition and/or UL transmission (S61).

In addition, the autonomous vehicle 10 receives a UL grant from the 5G network in order to transmit specific information (S62).

The UL grant includes information as to the number of repeated transmission times of the specific information. The specific information is repeatedly transmitted based on the information as to the number of repeated transmission times (S63).

In addition, the autonomous vehicle 10 transmits the specific information to the 5G network based on the UL grant.

Repeated transmission of specific information is carried out through frequency hopping. Transmission of first specific information may be achieved through a first frequency resource, and transmission of second specific information may be achieved through a second frequency resource.

The specific information may be transmitted through a narrow band of 6RB (Resource Block) or 1RB (Resource Block).

In addition, the autonomous vehicle 10 receives a DL grant from the 5G network in order to receive a response to the specific information (S64).

In addition, the autonomous vehicle 10 receives information (or a signal) associated with remote control from the 5G network based on the DL grant (S65).

The above-described 5G communication technology may be applied in a state of being combined with the methods proposed in the present disclosure and described with reference to FIGS. 1 to 13, and may be supplemented to concretize or clarify technical features of the methods proposed in the present disclosure.

The vehicle 10 disclosed in the present disclosure is connected to an external server through a communication network, and is movable along a predetermined path without intervention of a driver using autonomous traveling technology. The vehicle 10 may be embodied using an internal combustion engine vehicle including an engine as a power source, a hybrid vehicle including an engine and an electric motor as a power source, an electric vehicle including an electric motor as a power source, etc.

In the following embodiment, the user may be interpreted as a driver, a passenger, or a possessor of a user terminal. The user terminal may be a mobile terminal portable by the user to execute telephone communication and various applications, for example, a smartphone, without being limited thereto. For example, the user terminal may be interpreted as a mobile terminal, a personal computer (PC), a notebook computer, or an autonomous vehicle system.

In the autonomous vehicle 10, the type and occurrence frequency of accidents may be greatly varied in accordance with ability to sense surrounding dangerous factors in real time. The path to a destination may include sections having different danger levels in accordance with various causes such as weather, features, traffic congestion, etc. In accordance with the present disclosure, insurance needed on a section basis is informed when a destination of the user is input, and insurance information is updated in real time through monitoring of dangerous sections.

At least one of the autonomous vehicle 10 of the present disclosure, a user terminal or a server may be linked to or combined with an artificial intelligence module, a drone (unmanned aerial vehicle (UAV), a robot, an augmented reality (AR) device, devices associated with virtual reality (VR) and 5G services, etc.

For example, the autonomous vehicle 109 may operate in linkage with at least one artificial intelligence module included in the vehicle 10 and a robot.

For example, the vehicle 10 may co-operate with at least one robot. The robot may be an autonomous mobile robot (AMR) which is autonomously movable. The mobile robot is configured to be autonomously movable and, as such, is freely movable. The mobile robot may be provided with a plurality of sensors to enable the mobile robot to bypass an obstacle during travel and, as such, may travel while bypassing obstacles. The mobile robot may be a flying robot (for example, a drone) including a flying device. The mobile robot may be a wheeled robot including at least one wheel, to move through rotation of the wheel. The mobile robot may be a leg type robot including at least one leg, to move using the leg.

The robot may function as an apparatus for supplementing convenience of the user of the vehicle. For example, the robot may perform a function for transporting a load carried in the vehicle 10 to a user's final destination. For example, the robot may perform a function for guiding a way to a final destination to the user having exited the vehicle 10. For example, the robot may perform a function for transporting the user having exited the vehicle 10 to a final destination.

At least one electronic device included in the vehicle may perform communication with the robot through the communication device 220.

At least one electronic device included in the vehicle 10 may provide, to the robot, data processed in at least one electronic device included in the vehicle 10. For example, at least one electronic device included in the vehicle 10 may provide, to the robot, at least one of object data indicating an object around the vehicle 10, map data, state data of the vehicle 10, position data of the vehicle 10 or driving plan data of the vehicle 10.

At least one electronic device included in the vehicle 10 may receive, from the robot, data processed in the robot. At least one electronic device included in the vehicle 10 may receive at least one of sensing data produced in the robot, object data, robot state data, robot position data or robot movement plan data.

At least one electronic device included in the vehicle may generate a control signal further based on data received from the robot. For example, at least one electronic device included in the vehicle 10 may compare information as to an object produced in an object detection device with information as to an object produced by the robot, and may generate a control signal based on compared results. At least one electronic device included in the vehicle 10 may generate a control signal in order to prevent interference between a travel path of the vehicle 10 and a travel path of the robot.

At least one electronic device included in the vehicle may include a software module or a hardware module (hereinafter, an artificial intelligence (AI) module) realizing artificial intelligence. At least one electronic device included in the vehicle 10 may input acquired data to the artificial intelligence module, and may use data output from the artificial intelligence module.

The artificial intelligence module may execute machine learning of input data, using at least one artificial neural network (ANN). The artificial intelligence module may output driving plan data through machine learning of input data.

At least one electronic device included in the vehicle 10 may generate a control signal based on data output from the artificial intelligence module.

In accordance with an embodiment, at least one electronic device included in the vehicle 10 may receive data processed through artificial intelligence from an external device via the communication device 220. At least one electronic device included in the vehicle 10 may generate a control signal based on data processed through artificial intelligence.

The present disclosure as described above may be embodied as computer-readable code, which can be written on a program-stored recording medium. The recording medium that can be read by a computer includes all kinds of recording media on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc., and may include an embodiment having the form of a carrier wave (for example, transmission over the Internet). In addition, the computer may include a processor or a controller. Accordingly, it will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

1. An electronic device for a vehicle comprising:
at least one interface; and
at least one processor configured to:
receive, through the interface, a sensing signal generated by force applied to a steering wheel in a direction different from a rotation direction of the steering wheel, and
provide a control signal to switch a travel mode between a manual mode and an autonomous mode based on the sensing signal.

2. The electronic device for the vehicle according to claim 1, wherein the processor is configured to provide a first control signal to switch the travel mode from the manual mode to the autonomous mode upon receiving a first sensing signal generated by force applied in a first direction.

3. The electronic device for the vehicle according to claim 2, wherein the processor is configured to provide a control signal to position the steering wheel at a normal position where there is no rotation of the steering wheel while cutting off operative connection of the steering wheel to steered wheels, upon receiving the first sensing signal.

4. The electronic device for the vehicle according to claim 3, wherein the processor is configured to provide a control signal to hide at least a portion of the steering wheel into a cockpit, upon receiving the first sensing signal.

5. The electronic device for the vehicle according to claim 2, wherein the processor is configured to provide a second sensing signal to switch the travel mode from the autonomous mode to the manual mode, upon receiving a second sensing signal generated by force applied in a second direction different from the first direction.

6. The electronic device for the vehicle according to claim 5, wherein the processor is configured to provide a control signal to expose at least a portion of the steering wheel in a hidden state, upon receiving the second sensing signal generated by the force applied in the second direction different from the first direction.

7. The electronic device for the vehicle according to claim 6, wherein the processor is configured to provide a control signal to operatively connect the steering wheel and the steered wheels, upon receiving the second sensing signal.

8. The electronic device for the vehicle according to claim 2, wherein the processor is configured to:
receive information as to a travel section through the interface; and
provide a second control signal to switch the travel mode from the autonomous mode to the manual mode, upon determining that a residual section for autonomous travel is not greater than a reference distance.

9. The electronic device for the vehicle according to claim 8, wherein the processor is configured to provide a control signal to output an interface providing information as to a time when the travel mode is switched from the autonomous mode to the manual mode.

10. The electronic device for the vehicle according to claim 8, wherein the processor is configured to:
receive information as to a state of a user through the interface; and
provide a control signal to park the vehicle in a safe area, upon determining the state of the user to be an impossible state the manual travel.

11. The electronic device for the vehicle according to claim 1, wherein the processor is configured to:
receive an electrical signal generated from a user input device through the interface; and
provide the control signal upon receiving the sensing signal in a state of receiving the electrical signal.

12. The electronic device for the vehicle according to claim 1, wherein the processor is configured to provide a control signal to output a user intention identification interface, upon receiving the sensing signal.

13. The electronic device for the vehicle according to claim 1, wherein the processor is configured to provide the control signal, upon determining that a sensing value based on the sensing signal is not lower than a reference value.

14. The electronic device for the vehicle according to claim 1, wherein the processor is configured to provide the control signal, upon continuously receiving the sensing signal for a predetermined time or more.

15. The electronic device for the vehicle according to claim 1, wherein the processor is configured to:
provide a first control signal to switch the travel mode to a fully autonomous mode, upon receiving a first sensing signal generated by force applied to the steering wheel in a first state;
provide a second control signal to switch the travel mode to a semi-autonomous mode, upon receiving a second sensing signal generated by force applied to the steering wheel in a second state; and
wherein the first state is a state in which the steering wheel is closer to a cockpit than in the second state.

16. The electronic device for the vehicle according to claim 1, wherein the processor is configured to:
receive information as to a travel section through the interface; and
provide a control signal to output an interface rejecting an autonomous mode switching, upon determining that a residual section for autonomous travel is not greater than a reference distance at a time when the sensing signal is received by the processor

17. The electronic device for the vehicle according to claim 16, wherein the processor is configured to determine whether the residual section for autonomous travel possible section is not greater than the reference distance when the steering wheel is in a first state; and
wherein the first state is a state in which the steering wheel is closer to a cockpit than in a steering wheel state in the manual mode.

18. The electronic device for the vehicle according to claim 1, wherein the processor is configured to provide a control signal to output an interface providing information as to a time when the travel mode is switched from the manual mode to the autonomous mode.

19. An electronic device for a vehicle comprising:
a processor configured to:
switch a travel mode from a manual mode to an autonomous mode, upon sensing force pushing a steering wheel in a forward direction of the vehicle through a sensor, and
switch the travel mode from the autonomous mode to the manual mode, upon sensing force pulling the steering wheel in a rearward direction of the vehicle through the sensor.

20. An operating method of an electronic device for a vehicle comprising:
receiving, by at least one processor, a sensing signal generated by force applied to a steering wheel in a direction different from a rotation direction of the steering wheel; and
providing, by at least one processor, a control signal to switch a travel mode between a manual mode and an autonomous mode based on the sensing signal.
